(19) United States
(12) Patent Application Publication
(10) Pub. No.: US 2026/0343635 A1
(43) Pub. Date: Oct. 29, 2026

(54) RE-JOIN TIME OPTIMIZATION IN CHANNEL HOPPING NETWORKS

(71) Applicant: Texas Instruments Incorporated, Dallas, TX (US)

(72) Inventors: Kumaran Vijayasankar, Allen, TX (US); Liangcheng Tao, Plano, TX (US); Weibo Liang, Frisco, TX (US); Henry Isobe, McKinney, TX (US); Thomas Almholt, Murphy, TX (US)

(21) Appl. No.: 19/647,438

(22) Filed: Apr. 14, 2026

Related U.S. Application Data
(60) Provisional application No. 63/793,226, filed on Apr. 23, 2025.

(51) Int. Cl. H04W 76/10

(52) U.S. Cl. CPC H04W 76/10

(57) ABSTRACT

Systems, apparatus, articles of manufacture, and methods for re-join time optimization in multi-hop unsynchronized channel hopping networks are disclosed. An example method includes connecting to a wireless network that utilizes channel hopping, determining a current sequence interval based on an earlier sequence interval and difference between a current time and an earlier time associated with the earlier sequence interval, and communicating on the wireless network utilizing the current sequence interval.

### RELATED APPLICATIONS

This patent claims priority to U.S. Provisional Patent Application Ser. No. 63/793,226, filed Apr. 23, 2025. U.S. Provisional Patent Application Ser. No. 63/793,226 is hereby incorporated herein by reference in its entirety.

### FIELD OF THE DISCLOSURE

This disclosure relates generally to communication devices and, more particularly, to methods and apparatus for re-joining communication devices to networks.

### BACKGROUND

Many wireless networks utilize channel hopping to avoid interference, improve security, and increase reliability. Channel hopping is a network feature by which a device hops or moves to different channels (frequency bands). The channel hopping behavior can be used to achieve increased network throughput by promoting simultaneous data transfer over multiple channels between different pairs of devices or to achieve reliability in tough channel conditions by exploiting the channel diversity. Channel hopping can be achieved through many different methods such as a synchronous method called Time Slotted Channel Hopping (TSCH) or an asynchronous method called un-slotted channel hopping (e.g., as defined in IEEE 802.15.4 or IEC 62591 aka Wireless HART). Many standards also exist that use such channel hopping media access control (MAC) to define MAC protocols for different applications. For example, Wi-SUN Alliance has proposed a Field Area Network (FAN) specification that specifies how to use unslotted channel hopping for smart grid applications.

Some wireless networks utilize unslotted channel hopping across multiple hops for robust connectivity and spectrum efficiency. In such networks, each device follows a broadcast channel-hopping schedule for synchronization, while unicast transmissions occur on channel-specific schedules that are independent of one another. However, in an unslotted system devices can transmit at any time without waiting for a time slot. When a device experiences a power interruption, it performs a process to re-join to the network, establish security credentials, and coordinate routing relationships before normal operation can resume. Such re-join processes may be defined by a specification. For example, one such specification is the Wireless Smart Ubiquitous Network (Wi-SUN) Field Area Network (FAN), which is a wireless standard for wireless mesh networks.

### BRIEF DESCRIPTION OF THE DRAWINGS

FIG. 1 illustrates an arrangement of devices in a network, such as a channel hopping network, according to some embodiments.

FIG. 2 illustrates an example broadcast interval for devices in a network, such as a channel hopping network, according to some embodiments.

FIG. 3 illustrates example unicast channel hopping slots in a network, such as a channel hopping network, according to some embodiments.

FIG. 4 illustrates an example communication between two devices in a network, such as a channel hopping network, according to some embodiments.

FIG. 5 illustrates example asynchronous transmissions in a network, such as a channel hopping network, according to some embodiments.

FIG. 6 illustrates an example device re-join process for a device in a network, such as a channel hopping network, according to some embodiments.

FIG. 7 illustrates an example device re-join process for a device in a network, such as a channel hopping network, according to some embodiments.

FIG. 8 (split into FIG. 8A and FIG. 8B in the drawings) is a flowchart representative of example machine readable instructions and/or example operations that may be executed, instantiated, and/or performed by example programmable circuitry to re-join a device to a wireless network after an interruption, according to some embodiments.

FIG. 9 is a flowchart representative of example machine readable instructions and/or example operations that may be executed, instantiated, and/or performed by example programmable circuitry to re-join a device to a wireless network after an interruption, according to some embodiments.

FIG. 10 illustrates an example Unicast Fractional Sequence Interval (UFSI) and Broadcast Interface Offset (BIO) for a network, such as a channel hopping network, according to some embodiments.

FIG. 11 illustrates an example of mapping broadcast interval offset to a sequence interval in a network, such as a channel hopping network, according to some embodiments.

FIG. 12 is a flowchart representative of example machine readable instructions and/or example operations that may be executed, instantiated, and/or performed by example programmable circuitry to re-join a device to a wireless network after an interruption, according to some embodiments.

FIG. 13 is a block diagram of an example processing platform including programmable circuitry structured to execute, instantiate, and/or perform the example machine readable instructions and/or perform the example operations of FIGS. 8, 9, 12.

### SUMMARY

For Re-join Time Optimization in Multi-Hop Unsynchronized Channel Hopping Networks, an example device includes a transceiver; a processor configured to: establish, via the transceiver, a connection with a wireless network that utilizes channel hopping; determine a current sequence interval based on an earlier sequence interval and difference between a current time and an earlier time associated with the earlier sequence interval; and communicate, via the transceiver, on the wireless network utilizing the current sequence interval. Other examples are described.

For Re-join Time Optimization in Multi-Hop Unsynchronized Channel Hopping Networks, an example method includes connecting to a wireless network that utilizes channel hopping; determining a current sequence interval based on an earlier sequence interval and a difference between a current time and an earlier time associated with the earlier sequence interval, and communicating on the wireless network utilizing the current sequence interval. Other examples are described.

For Re-join Time Optimization in Multi-Hop Unsynchronized Channel Hopping Networks, an example non-transitory computer readable medium including instructions that connect to a wireless network that utilizes channel hopping; determine a current sequence interval based on an earlier sequence interval and difference between a current time and an earlier time associated with the earlier sequence interval, and communicate on the wireless network utilizing the current sequence interval. Other examples are described.

### DETAILED DESCRIPTION

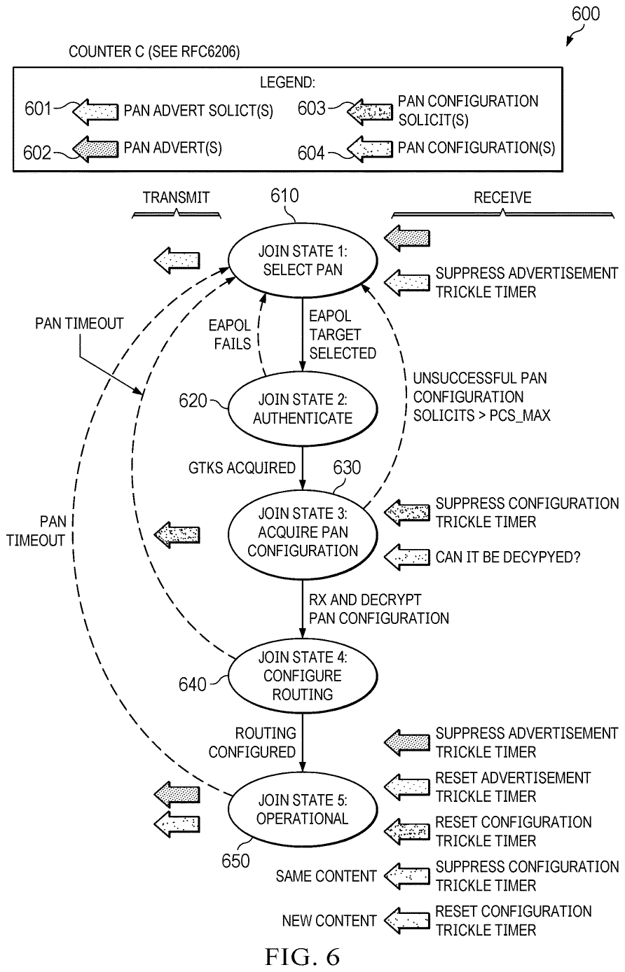

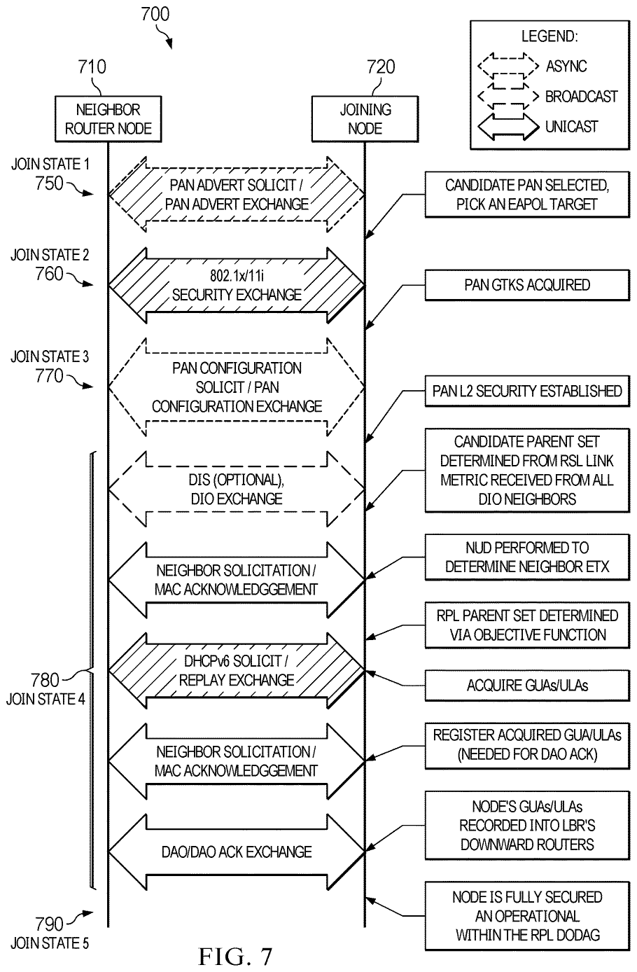

Devices joining networks typically follow a sequence of operations to establish a connection. For example, a network standard like Wi-SUN FAN defines a set of operations, communications, etc. to establish a connection (e.g., as disclosed further in conjunction with FIGS. 6 and 7). Re-joining such a network after a power interruption typically requires a sequence of discovery, configuration, and routing steps, which can consume significant time.

Example approaches for joining and operating within channel hopping networks are described in U.S. Patent Application Publication No. 2017/0317713 entitled “PSEUDO CHANNEL HOPPING USING SCAN DWELL TIMES IN MESH NETWORKS WITHOUT TIME SYNCHRONIZATION”, U.S. Patent Application Publication No. 2018/0368184 entitled “CHANNEL HOPPING AWARE CHANNEL ACCESS AND RE-TRANSMISSION”, U.S. Patent Application Publication No. 2025/0126072 entitled “TIME CRITICAL PACKET TRANSMISSION”, and U.S. Patent Application Publication No. 2017/0310358 entitled “SLEEPY DEVICE OPERATION IN ASYNCHRONOUS CHANNEL HOPPING NETWORKS”. U.S. Patent Application Publication No. 2017/0317713, U.S. Patent Application Publication No. 2018/0368184, U.S. Patent Application Publication No. 2025/0126072, and U.S. Patent Application Publication No. 2017/0310358 are hereby incorporated herein by reference in their entireties.

Example embodiments described herein accelerate reconnection to a network by leveraging stored broadcast and unicast hopping states, parent-neighbor relationships, and real-time clock information to skip or shorten standard join phases. In some implementations, some of the components of a re-join procedure may be skipped when the same network identifier (e.g., personal area network (PAN) identifier (ID)) and the same network name will be utilized after the power outage. In addition, propagation delays in the information object dissemination can be reduced by shortening the information object interval and tightening neighbor-discovery timeouts. These measures allow the device to resume network participation with a reduced set of messages while still maintaining normal network operations for later phases.

In some embodiments disclosed herein, parent, child, neighbor, and/or channel-hopping information is stored so that, upon power restoration, each device can immediately assume its previous neighbors are reachable. The device only needs to capture the broadcast-channel timing from a PAN-configuration frame to recalibrate its own unicast hopping sequence and then quickly register with its parent using MAC-level neighbor solicitation and data exchanges (e.g., Routing Protocol for Low-Power and Lossy Networks (RPL) Destination Advertisement Object (DAO)). In some such examples, the re-join path is shortened by eliminating a full discovery loop. In addition, in some such examples, stored routing and network address (e.g., Internet Protocol version 6 (IPV6)) information may be leveraged to avoid renegotiating such parameters when the network topology and addresses remain unchanged.

In some embodiments, random access memory (RAM) and a real-time clock (RTC) state are retained during power loss. For example, a battery or other backup power source that provides sufficient power to retain RAM and RTC may be included in a device. During a recovery from a power loss, unicast hopping can be calibrated based on broadcast hopping. Devices equipped with capacitors or battery backup can retain RAM and an internal real-time clock during brief outages, allowing them to resume operation with minimal drift. When outages are longer, devices may store a relationship between their unicast hopping position and the network's broadcast schedule (UFSI-BIO mapping). Upon receiving a PAN-config frame, a device may compute the expected unicast position and resume hopping exactly where it left off, even without a direct frame from their former parent.

A device implementing the techniques of this disclosure may achieve network formation quicker than other devices. This benefit may be especially useful for devices that operate in environments with an intermittent power supply, such as solar power, wind power, or hydroelectric power, and/or in regions with electrical grid outages. Of course, these advantages are merely examples, and no advantage is required for any particular embodiment.

Various approaches to optimize and reduce network re-join time in a wireless mesh network (e.g., employing unslotted channel hopping, such as a Wi-SUN Field Area Network) are described herein. In some examples, the various approaches may be utilized under different assumptions regarding network state, device hardware capabilities, and available timing information. The approaches may be utilized individually or in combination, as described further below.

In a first approach, which may be referred to as Network Configuration Optimization, a re-join time is reduced by optimizing network parameters and skipping network discovery phases based on determining that certain assumptions regarding device and network capabilities are present. For example, this approach may assume that a network with the same PAN identifier and network name will either be retained by a border router or re-initiated by the border router following a power outage, allowing the device to skip the advertisement discovery phase. Under this approach, the device may optimize network parameters and bypass the network discovery phase entirely. In this approach, it may further be assumed that parent and neighboring devices will be available upon power resumption and that only time synchronization with the parent device is required rather than a full neighbor discovery cycle. This approach may function even in cases where the full network has not resumed. In some examples, the device will have a reduced set of neighbors from which to select a parent according to this approach.

In a second approach, which may be referred to as Whole Network Resumption, re-join time may be reduced by assuming that the entire network will be resumed following a power outage and assuming that the device's previously known parent and neighbor relationships remain valid. In some examples, IPv6 address assignments of devices may remain unchanged by the Network Management System during the power outage. Under this assumption, the device can assume that its parent and neighboring devices are reachable as before, requiring only time synchronization per parent rather than a full network re-discovery. The example device stores parent, child, and neighbor information together with channel hopping information in non-volatile memory. Upon power resumption, the device accesses this stored information to re-establish connectivity. The approach is effective even when the full network has not resumed, though performance may be sub-optimal in such cases due to the reduced availability of neighboring devices.

In a third approach, which may be referred to as RAM and RTC Retention, a device is equipped with sufficient capacitor backup, battery backup, or other auxiliary power source to retain the contents of volatile memory (e.g., RAM) and maintain a running real-time clock (RTC) during the power outage. Under this approach, RAM is retained through the power outage and the RTC clock continues to run, allowing the device to preserve its complete network state, which may include neighbor table entries, parent information, channel hopping parameters, routing state, and security credentials. Upon power resumption, the device resumes network operation from the point at which it has last connected prior to power loss (or other network loss). In some examples, the device will perform a time synchronization step with the border router to account for any clock drift accumulated during the outage. Because the network state is preserved in RAM, the device does not need to perform re-discovery, re-authentication, or parent selection, enabling resumption in a significantly shorter time than a full re-join sequence would require.

In a fourth approach, which may be referred to as Calibrating Unicast Hopping Based on Broadcast Hopping, the device stores the relationship between its unicast hopping schedule and the network's broadcast hopping schedule. The example device uses this stored relationship to recalibrate its unicast hopping sequence upon power resumption without requiring an explicit unicast timing frame from a neighboring device. Under this approach, the example device stores the timing information of its known parent devices and can assume that those parent devices have also made a similar correction to their own unicast hopping sequences following power resumption. Upon receiving broadcast timing information from a PAN Configuration frame, the device recomputes its expected unicast hopping position using the stored UFSI-to-broadcast-schedule mapping and resumes unicast hopping from the recalibrated position. Because parent devices are expected to have applied the same correction, the device can further compute the expected unicast hopping positions of its known parents without receiving a direct frame from them, enabling MAC-level unicast communication to be established immediately after broadcast synchronization is achieved.

Each of the four approaches described above is discussed in more detail herein. Each of the approaches may be utilized independently to reduce re-join time under the specific conditions and hardware capabilities to which each approach is suited. However, the approaches are not mutually exclusive, and one or more of the approaches may be combined to achieve further reductions in re-join time or to provide for recovery across a range of network conditions and device configurations. For example, a device employing RAM and RTC retention may additionally apply the unicast hopping recalibration approach to further accelerate re-synchronization with neighboring devices after power resumption. Similarly, a device applying the network configuration optimization approach may also leverage stored parent and neighbor information consistent with the whole network resumption approach to minimize the number of over-the-air exchanges required.

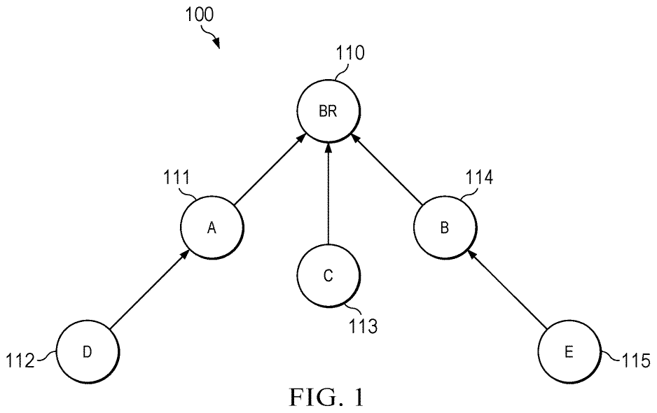

FIG. 1 illustrates an arrangement of devices in a network, such as a channel hopping network, according to some embodiments. FIG. 1 is an illustration of an example tree 100 of devices 110-915. According to the illustrated example, the tree includes a border router 110. Devices 111, 113, and 114 are one hop away from the border router 110 and are, thus, level 1 routers. Devices 112 and 115 are two hops away from the border router 110 and, thus, are level 2 routers. The arrows from one device to another indicate a direction of increase in the hierarchy of the tree 100. In one example, router 112 is a child router of router 111, as router 112 communicates to border router 110 via router 111. Similarly, router 115 may be a child router of 114 because router 115 communicates to border router 110 via router 114. Routers 112, 113, and 115 do not have any child routers. The example arrangement may be utilized in a channel hopping network such as an unsynchronized channel hopping network. For example, the tree 100 may include devices connected to the routers (e.g., edge devices such as internet of things devices, home and business utility meter devices, control devices such as street light controls, thermostats, etc.).

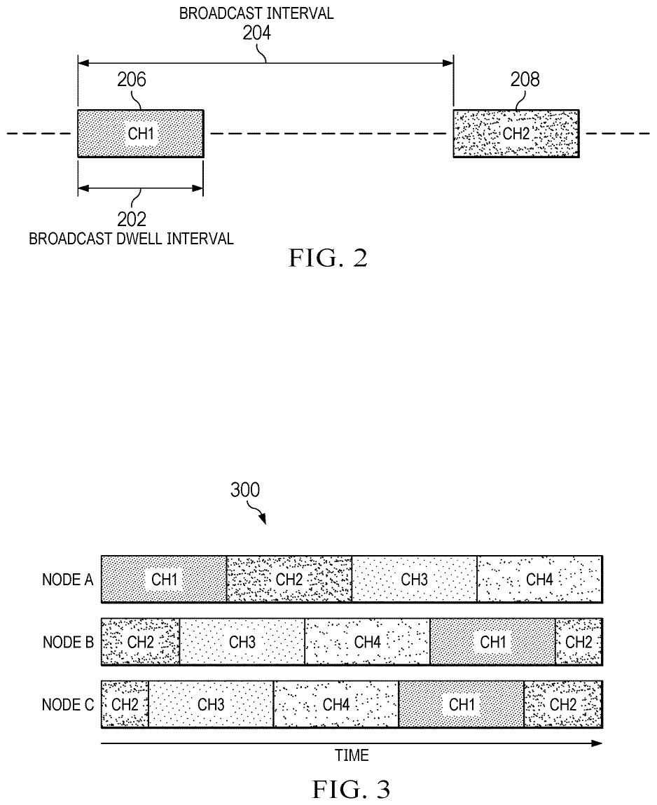

FIG. 2 illustrates an example broadcast interval 200 for devices in a network, such as a channel hopping network, according to some embodiments. For example, the network may be an unslotted Wi-SUN FAN network that uses a multi-hop, channel-hopping MAC. In such networks, some or all of the devices follow the same broadcast sequence, so the broadcast dwell interval 202 determines how long a device stays on a particular channel (e.g., channel one 204, channel two 206, etc.) before moving to the next one. The broadcast interval 200 is the sum of all dwell times 202, which is the period between successive broadcast slots (e.g., how often a device opens a broadcast channel hopping slot). Because all devices share the broadcast interval 200, they are synchronized on when each channel will be active, which enables every device to receive broadcast frames on the common channel during the dwell times 202 without collision.

FIG. 3 illustrates example unicast channel hopping slots 300 in a network, such as a channel hopping network, according to some embodiments. During a broadcast interval, after the broadcast dwell time, the devices shall follow their own receiver directed unicast channel hopping schedules 300. The unicast channel hopping slots need not be synchronized to each other. The unicast schedules are receiver directed in the sense that a device shall transmit a frame to a receiver in the channel specified by the receiver (e.g., using Carrier Sense Multiple Access with Collision Avoidance (CSMA/CA).

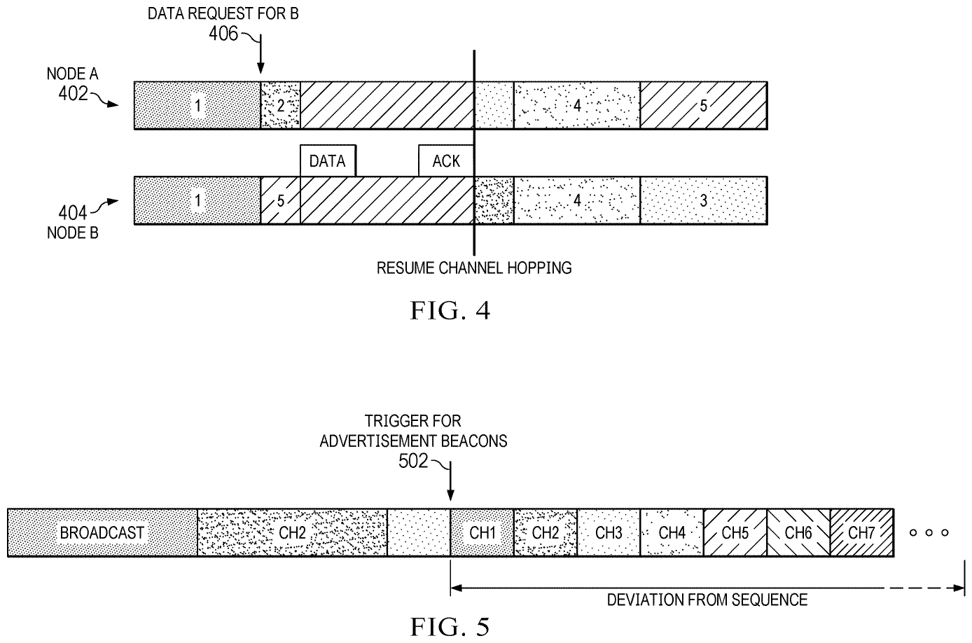

FIG. 4 illustrates an example communication between two devices in a network, such as a channel hopping network, according to some embodiments. According to the illustrated example, a first device 402 is communicating with a second device 404. FIG. 4 illustrates the case in which a unicast transmission that extends past an end of a single slot. For example, in an unslotted Wi-SUN network each device follows its own receiver-directed hopping schedule. A transmission may occupy more than one scheduled slot if the data payload is larger than what fits in one slot. For example, as shown in FIG. 4, the first device 402 transmits a data request 406 on a channel that the intended receiver (e.g., the second device 404) is currently listening (e.g., channel 5). The transmission begins in one scheduled slot but continues into the next adjacent slot(s) until the entire frame is sent. This “extend-into-adjacent-slot” behavior is utilized because the slot period is limited, and the protocol allows a device to keep sending on successive slots as long as the receiver remains on the same channel.

FIG. 5 illustrates example asynchronous transmissions in a network, such as a channel hopping network, according to some embodiments. According to the illustrated example, exchanging information (e.g., timing information) utilizes specific information elements (e.g., as defined in Wi-SUN FAN specification). For example, two information elements may be utilized. A first example information element is a Unicast Timing Information Element (UTT-IE), which carries the timing information for a receiving device to track a transmitting device's channel hopping sequence. A second example information element is a Unicast Schedule Information Element (US-IE), which carries information about the channel number on which a device is currently listening (e.g., for devices with fixed hopping) and/or a list of hopping channels, a sequence, and corresponding hopping pattern. Such a system offers broadcast and unicast communication schemes. However, to support a broadcast scheme, a central “Parent Device” may be utilized. Such a parent device transmits frames with timing information that are used for synchronization among other devices to maintain a common broadcast schedule.

In addition to broadcast and unicast transmission, some network protocols support an asynchronous transmission method as illustrated in FIG. 5. Such transmissions can be initiated by a device at any point of time irrespective of unicast or broadcast dwell times. For example, an advertisement beacon may be started by a device that initiates an asynchronous transmission. For example, a transmission may not be bound to any scheduled broadcast dwell or unicast slot. Such a transmission can be sent at any time. Such a device transmits the beacon back-to-back on multiple channels so that every device can receive it regardless of its current receiving channel. Such a beacon is typically carried in a broadcast-level neighbor solicitation that includes an Address Registration Option, allowing the parent to receive it during its broadcast dwell period and then reply with a unicast solicitation that contains the timing information needed for the re-join procedure. The frames may be used during an initial network discovery and for exchanging configuration data across the network.

FIG. 6 illustrates an example device re-join process for a device in a network, such as a channel hopping network, according to some embodiments. FIG. 6 illustrates a state machine diagram 600 for a network join and re-join procedure for a wireless mesh network device, such as a device operating in accordance with the Wi-SUN protocol. The diagram 600 depicts transitions between four join states 610, 620, 630, and 640. The diagram also illustrates message types exchanged during each state and the timer actions triggered by received messages. Transmit-side behavior is shown on the left and receive-side behavior is shown on the right.

Join state 1 (610) is an initial state in which the device has not yet identified or associated with a network coordinator. In this state 610, the device transmits PAN Advertisement Solicits 601 to solicit network advertisements from neighboring routers or coordinators. Upon receiving a PAN Advertisement 602 in this state, the device suppresses the Advertisement Solicit trickle timer (e.g., as described in RFC 6206). Upon receiving a PAN Advertisement Solicit 601 in this state, the device resets the Advertisement timer.

When an authentication target (e.g., an Extensible Authentication Protocol over LAN (EAPOL)) is selected, the device transitions from Join State 1 610 to Join State 2 (Acquire Keys) 620. If authentication fails, the state machine returns to Join State 1 610 via a failure arc.

Upon successful acquisition of encryption keys (e.g., Group Temporal Keys (GTKs)), the device transitions from Join State 2 620 to Join State 3 (Acquire PAN Config) 630. In Join State 3 630, the device transmits PAN Configuration Solicits 603 on the transmit side. On the receive side, when the device receives PAN Config Solicits 603, the device suppresses the Advertisement Solicit trickle timer. Upon receipt of PAN Config(s) 604, the device determines if the PAN configuration can be decrypted. If the number of unsuccessful PAN Configuration Solicits exceeds a threshold PCS_MAX, the state machine returns to Join State 1 610.

When the device successfully receives and decrypts a PAN Configuration Beacon, it transitions from Join State 3 630 to Join State 4 (Configure Routing) 640. In Join State 4 640, the device sets up its network route to a border router. If a PAN timeout occurs, the device transitions back to Join State 1 610.

Once routing is configured, the device transitions to Join State 5 (Operational) 650. Join State 5 650 presents the Operational State in which the device has successfully authenticated and connected to the network. In this state, the device is fully functional, capable of transmitting application data, and acts as a node within the mesh network. The device transmits PAN Advert(s) 602 and PAN config(s) 604 to maintain network synchronization, facilitate new node joining, and support mesh topology maintenance. Also, in Join State 5 650, the device receives PAN Advert(s) 602 to obtain periodic updates to maintain network synchronization and discover potential topology changes. The device may suppress its advertisement trickle timer to avoid network congestion. The device receives a PAN Advert Solicit 601 and resets the advertisement trickle timer to avoid redundant transmissions, ensuring that a network advertisement is sent only when requested while efficiently managing the network update interval. The device may additionally receive PAN Config solicit(s) 603 and PAN Config(s) 604. During the reception, the device may suppress and reset a configuration trickle timer. If a PAN timeout occurs, the device transitions back to Join State 1 610 to restart the join process.

FIG. 7 illustrates an example device re-join process for a device in a network, such as a channel hopping network, according to some embodiments. FIG. 7 illustrates a message sequence diagram 700 depicting the bootstrap messaging flow for a joining device seeking to become fully operational within a wireless mesh network (e.g., a network employing layer-3 routing, such as a Wi-SUN). The diagram 700 includes two participants: 1) a Neighbor Router Device 710 representing an already-joined network router and 2) a Joining Device 720 representing a device seeking network admission. Steps shown with cross-hatching may be skipped as described in embodiments.

Join State 1 750 includes the advertisement discovery phase. During Join State 1 741 a PAN Advertisement Solicit/PAN Advertisement Exchange is performed between the Neighbor Router Device 710 and the Joining Device 720. This exchange, depicted with cross-hatching to indicate that it may be skipped in some embodiments set forth herein, allows the Joining Device to discover candidate networks. Upon conclusion of Join State 1, the Joining Device selects a candidate PAN and identifies an EAPOL authentication target.

Join State 2 760 includes a security credential acquisition phase. During Join State 2 742 a security exchange (e.g., an 802.1x/11i) is performed between the Neighbor Router Device 710 and the Joining Device 720. This exchange, also depicted with cross-hatching to indicate that it may be skipped in some embodiments set forth herein, enables the Joining Device 720 to authenticate with the network and acquire the necessary security credentials. Upon successful completion, the Joining Device 720 acquires security keys (e.g., PAN Group Temporal Keys (GTKs)).

Join State 3 770 includes a PAN configuration phase. During Join State 3 770, a PAN Configuration Solicit/PAN Configuration Exchange is performed between the Neighbor Router Device 710 and the Joining Device 720. Upon successful completion of this exchange, security (e.g., PAN layer-2 security) is established.

Join State 4 780 includes routing establishment and address acquisition. Join State 3 770 includes multiple sequential message exchanges and internal device operations. For example, an optional Destination-Oriented Directed Acyclic Graph (DODAG) Information Solicitation (DIS) may be performed. Further, a DODAG Information Object (DIO) Exchange may be performed. Using obtained information, the Joining Device 720 determines a candidate parent set based on signal metrics (e.g., Receive Signal Link (RSL) metrics) received from DIO neighbors. Next, a Neighbor Solicitation/MAC Acknowledgement exchange is performed, which enables the Joining Device 720 to perform Neighbor Unreachability Detection (NUD) to determine neighbor information. The Joining Device 720 then determines its RPL parent set via an Objective Function. Next, a dynamic host configuration protocol version 6 (DHCPv6) Solicit/Reply Exchange is performed, depicted with cross-hatching to indicate that it may be skipped in some embodiments set forth herein. Thus, the Joining Device 720 may acquires Global Unicast Addresses and/or Unique Local Addresses (GUAs/ULAs). A second Neighbor Solicitation/MAC Acknowledgement exchange is then performed, enabling the Joining Device 720 to register its acquired GUAs/ULAs as needed for DAO acknowledgment. Finally, a DAO/DAO ACK Exchange is performed between the Joining Device 720 and the Neighbor Router Device 710, which records the device's GUAs/ULAs into downward routes of the Neighbor Border Router 710.

Join State 5 790 represents a terminal state, in which the Joining Device 720 is fully secured and operational within the RPL DODAG.

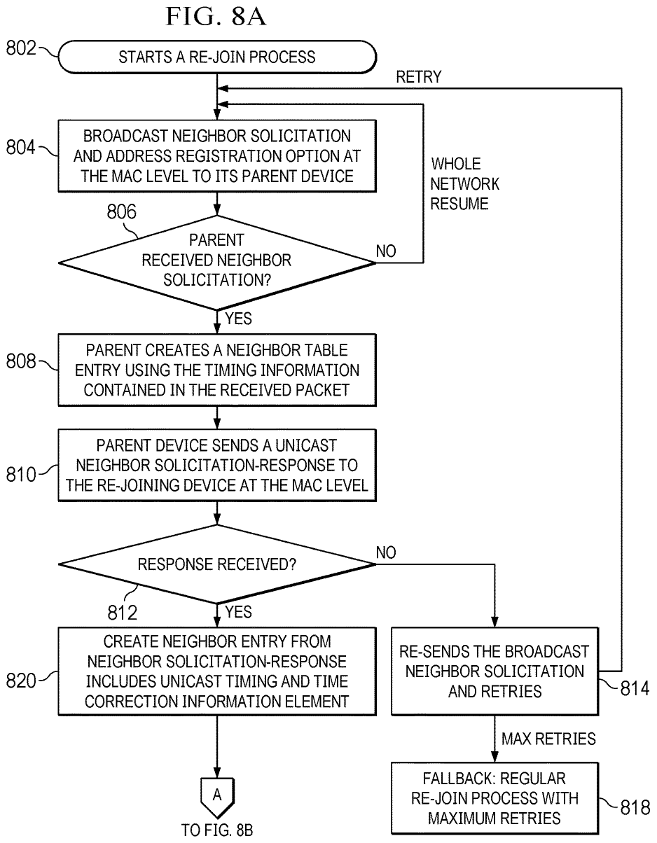

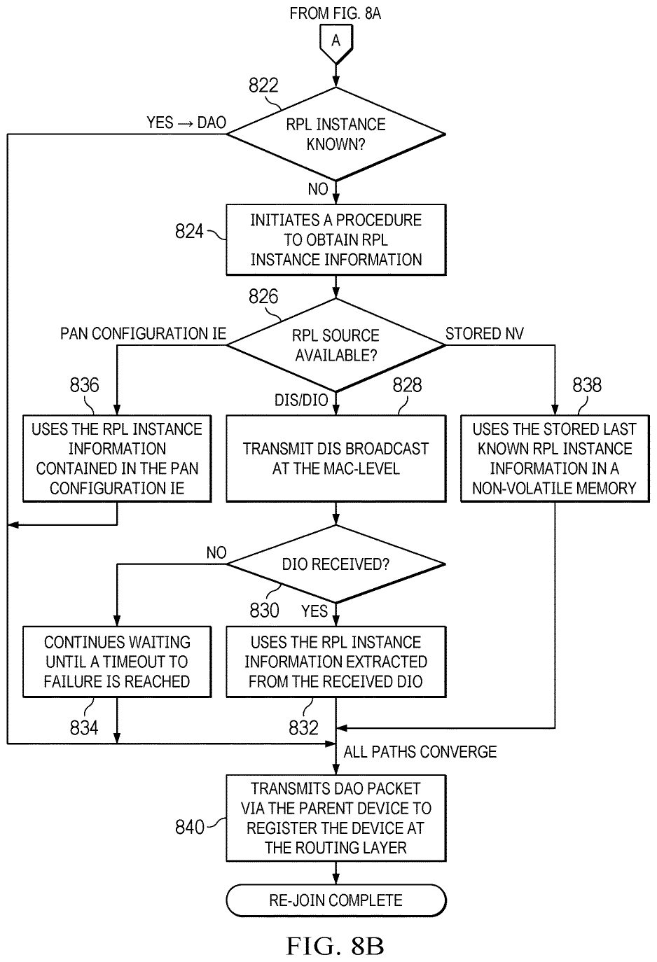

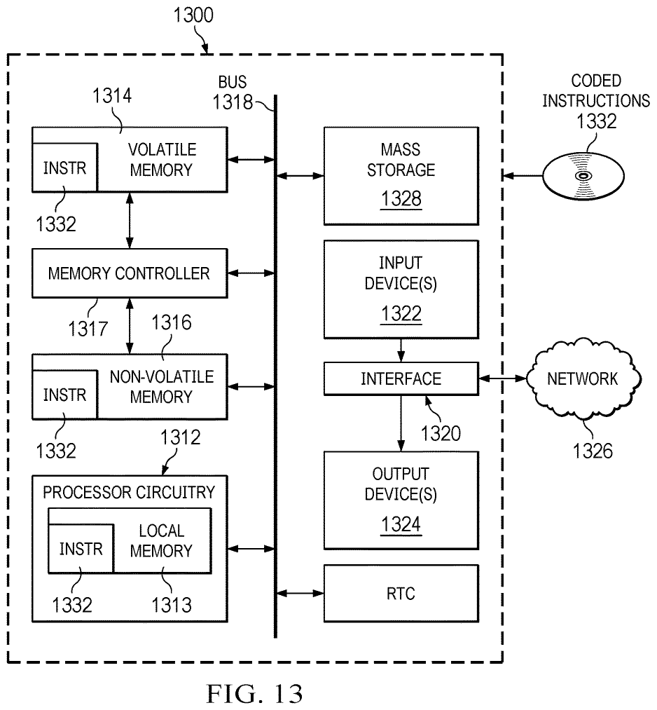

Flowchart(s) representative of example machine readable instructions, which may be executed by programmable circuitry to implement and/or instantiate the disclosed re-join processes and/or representative of example operations which may be performed by programmable circuitry to implement and/or instantiate the disclosed re-join processes, are shown in FIGS. 8, 9, 12. The machine readable instructions may be one or more executable programs or portion(s) of one or more executable programs for execution by programmable circuitry such as the programmable circuitry 1312 shown in the example processor platform 1300 discussed below in connection with FIG. 13 and/or may be one or more function(s) or portion(s) of functions to be performed by the example programmable circuitry (e.g., an FPGA). In some examples, the machine readable instructions cause an operation, a task, etc., to be carried out and/or performed in an automated manner in the real world. As used herein, “automated” means without human involvement. The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 8, 9, 12, many other methods of implementing the example re-join processes may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, and/or an FPGA. The programmable circuitry may include one or more CPUs, one or more GPUs, one or more VPUs, and/or one or more FPGAs located in the same package (e.g., the same integrated circuit (IC) package or in two or more separate housings), one or more CPUs, GPUs, VPUs, and/or one or more FPGAs in a single machine, multiple CPUs, GPUs, VPUs, and/or FPGAs distributed across multiple servers of a server rack, and/or multiple CPUs, GPUS, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above. The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein. The machine readable instructions described herein can be represented by any past, present, or future instruction language, scripting language, programming language, etc. For example, the machine readable instructions may be represented using any of the following languages: C, C++, Java, C-Sharp, Perl, Python, JavaScript, HyperText Markup Language (HTML), Structured Query Language (SQL), Swift, etc. As mentioned above, the example operations of FIGS. 8, 9, 12 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 8 is a flowchart representative of example machine readable instructions and/or example operations re-join process for a device in a Wi-SUN network following a power outage that may be executed, instantiated, and/or performed by programmable circuitry to reduce the re-join time following a power outage. In many networks (e.g., utility networks), devices and routers in the network are stationary and device location and relative channel conditions do not vary much (e.g., remain unchanged when a device recovers from a power outage). In such examples, in accordance with the example of FIG. 8, a device may stores parent, child, and neighbor information along with channel hopping information for the device in a non-volatile memory. After resumption from an outage, the device can assume that its parent and other devices are reachable as before. However, when the network is a channel hopping network, the resuming device would have lost the timing information of the neighbors as a device would not be able to know how long it was out during a power outage. In such a situation, the device would independently resume its hopping sequence and would still have to go through the PAN configuration exchange phase to get the broadcast timing information. However, once the device obtains the broadcast timing information, the device can utilize the knowledge that all devices in network follow the broadcast hopping schedule to reduce the re-join time according to the process illustrated in the flowchart 800.

The example re-join process 800 may be executed by a device seeking to re-establish connectivity within a wireless mesh network following an interruption in network participation (e.g., due to power outage, network interference, etc.). The flowchart 800 illustrates an accelerated re-join process that leverages MAC-level neighbor solicitation and address registration to restore routing connectivity without requiring a full network join sequence.

The process 800 begins when the device starts a re-join process (block 802). The device transmits a Broadcast Neighbor Solicitation (NS) and Address Registration Option (ARO) at the MAC level to its parent device (block 804). This broadcast transmission allows the parent device, which is listening on the same broadcast channel, to receive the NS packet at the MAC level.

Then the device determines whether the parent device has received the NS message (block 806). If the parent has not received the NS (the “No” branch), the process returns to block 804, where the device re-transmits the broadcast NS. If the parent has received the NS (the “Yes” branch), the parent creates a neighbor table entry using the timing information contained in the received packet (block 808). The neighbor table enables the parent to subsequently address MAC-level unicast packets to the re-joining device. Next, the parent device sends a unicast NS-response to the re-joining device at the MAC level (block 810).

Next, the device determines whether the re-joining device has received a response (block 812). If no response is received (the “No” branch), the device proceeds to block 814, where it re-sends the broadcast NS and retries. Control then returns to block 804 unless a maximum number of retries have occurred. If the maximum number of retries is reached without a successful response, the device proceeds to block 818, which represents a fallback to the specification-defined regular re-join process. For example rather than skipping any steps of the re-join for efficiency, the device may fallback to performing the entire re-join from the start.

Returning to block 812, if a response is received (the “Yes” branch of block 812), the re-joining device creates a neighbor table entry using the contents of the NS-response, which includes the UTT-IE (Unicast Timing and Time Correction Information Element) of the parent device (block 820). The device then determines whether the RPL instance information is already known to the re-joining device (block 822). If the RPL instance is known (the “Yes→DAO” branch), the device bypasses the RPL instance acquisition sequence and control proceeds directly to block 840 to transmit the DAO packet. If the RPL instance is not known (the “No” branch), the device proceeds to block 824, where it initiates a procedure to obtain RPL instance information.

The device then determines if an RPL source is available and which source to use (block 826). If device information is exchanged over a PAN Config IE (e.g., a vendor-specific information), the device proceeds to block 836, where it uses the RPL instance information contained in the PAN Configuration IE within a PAN Configuration frame. In some examples, this approach avoids the need to wait for a DIO packet by embedding RPL instance information in the PAN Config frame as a vendor-specific Information Element. From block 836, the process proceeds to block 840.

Returning to block 826, the device may alternatively send a broadcast DIS (e.g., broadcast at the MAC level) targeting the parent device to trigger it to send the DIO as soon as possible (block 828). If a DIO is received, the device uses the RPL instance information extracted from the received DIO (block 832) and control proceeds to block 840. If a DIO is not received, the device continues waiting (e.g., until a timeout to failure is reached) (block 834) and then control proceeds to block 840.

Returning to block 826, if the device has stored the last known RPL instance information in a memory (e.g., a non-volatile memory), the device uses the stored information (block 838) and control proceeds to block 840.

After control has converged at block 840, the device transmits a DAO packet via the parent device to register the device at the routing layer (block 840). This DAO transmission restores the device's presence in the RPL DODAG's downward routing table. The flowchart concludes and the device has been re-joined to the network.

In some examples, a device will make multiple attempts (retries) of this process before declaring that a parent is no longer available. In such a case, the device will revert back to a standard re-join process. This reversion ensures backward compatibility of the solution in cases where the entire network does not resume or if the Parent device does not support this feature. Since this process involves just a few packet exchanges and no wait time for detecting DIO or Parent selection, such a solution can enable re-join with a reduced duration.

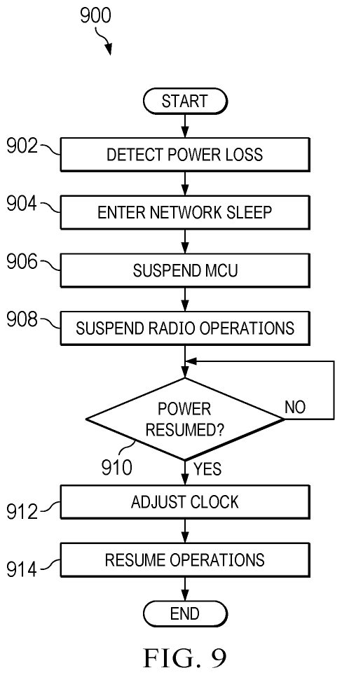

FIG. 9 is a flowchart 900 representative of example machine readable instructions and/or example operations re-join process that utilizes whole network resumption to reduce re-join time that may be executed, instantiated, and/or performed by programmable circuitry to re-joining a network after a power outage. The flowchart 900 illustrates an implementation in which a device is equipped with sufficient capacitor backup, battery backup, solar backup, or other power source to retain typically volatile memory (e.g., random access memory (RAM) contents and/or maintain a running real-time clock (RTC) during a power outage. In such an example, the device is able to suspend and resume network participation without performing a full re-join sequence.

The process begins at block 902 at which the device detects a power loss event (block 902). Detection of the power loss event may be triggered by a special interrupt configured to notify the device when the power supply transitions out of its normal operating range, signaling that the device is entering a network sleep state. Alternatively, any other detection approach may be utilized. Next, upon detection of the power loss event, the device enters a network sleep state (block 904). In an example network sleep state, the device suspends active network participation, ceasing transmission and reception activities. Because RAM retention is maintained through the power outage by the capacitor, battery backup, etc., the device preserves its network state, which many include neighbor table entries, parent information, channel hopping parameters, routing state, security credentials, etc. The information may be maintained across the power loss interval without requiring any re-discovery or re-authentication upon resumption.

According to the illustrated example, entering the network sleep state includes suspending MCU operations (block 906) and suspending radio operations (block 908). Suspending MCU operations places the device processing functions in a halted state consistent with the absence of normal operating power, while RAM contents are preserved by the backup power source. Suspending radio operations ceases RF transmission and reception activity, ensuring that the device does not generate erroneous or unsynchronized transmissions on the network during the power loss interval.

The device then waits for power to resume (block 910). During this monitoring for power, the RTC continues to run, maintaining a time reference that will be used to quantify the duration of the power loss interval upon resumption.

Next, upon detecting power resumption, the device adjusts its internal clock (block 912). Clock adjustment compensates for any timing drift or offset that may have accumulated in the RTC during the power loss interval. In the context of an unslotted channel hopping network such as a Wi-SUN Field Area Network or similar system, precise timing synchronization is utilized for successful MAC-level broadcast and unicast communication. Because the RTC continued running during the power outage, the elapsed duration of the outage is known, and the device can use this information to recalibrate its internal timing reference relative to the network's broadcast schedule, without waiting for an explicit timing frame from a neighboring device. The recalibrating may include recalibrating a unicast hopping sequence position.

In examples in which only RAM retention is available without a running RTC, the RTC value at the time of power loss may be stored in non-volatile memory and restored upon power resumption. In examples employing an external MCU or circuit, the external MCU may store the RTC time reference at the time of power outage and supply it back to the communication device once power is restored, with the communication device having previously stored its time reference relative to the external RTC in non-volatile memory so that it can recompute its intended time reference upon receiving the current external RTC value.

After performing the recalibration, the device resumes normal network operations (block 914). Resuming operations may include restoring the device's MCU and radio functions and re-engaging the device in active network participation using the preserved network state. Because RAM retention has maintained the device's neighbor table, parent information, security credentials, and channel hopping parameters across the power outage, and because the clock adjustment of block 912 has restored timing synchronization, the device is able to resume communication with its parent and neighboring devices without performing the network discovery, security exchange, or parent selection steps that would otherwise be required in a full re-join sequence. This significantly reduces the time required for the device to return to a fully operational state following a power outage.

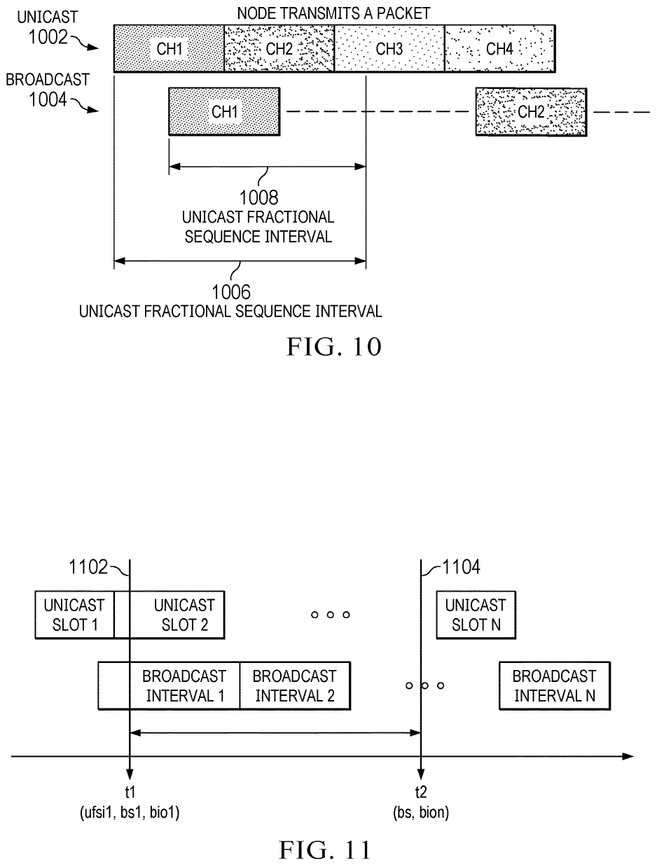

FIG. 10 illustrates a timing diagram depicting a relationship between a device's unicast channel hopping sequence 1002 and the network's broadcast channel hopping sequence 1004, as used in an unslotted channel hopping wireless mesh network such as a Wi-SUN Field Area Network or similar system. The diagram illustrates the Unicast Fractional Sequence Interval (UFSI) 1006 and Broadcast Fractional Offset (BFO) 1008 parameters that enable a device to recalibrate its unicast hopping position following a power outage or other interruption, without requiring explicit timing frames from neighboring devices.

The unicast timeline 1002 shows the device progressing through a sequence of consecutively occupied channels: CH1, CH2, CH3, and CH4. Each channel occupies one unicast dwell period, and the sequence progresses from left to right, illustrating the device's independent unicast channel hopping schedule.

The broadcast timeline 1004 shows the network's broadcast channel hopping sequence, which operates on a longer interval than the unicast dwell period. The broadcast timeline shows CH1 occupying the first broadcast dwell period, followed by a period during which no broadcast slot is active, and followed by CH2 representing the next broadcast slot. According to the illustrated example, the broadcast interval is greater than the unicast dwell time, such that at least one complete unicast hopping sequence is a subset of a single broadcast interval.

An example sequence interval 1006 (e.g., the Unicast Fractional Sequence Interval 1008) spans from the start of CH1 in the unicast channel hopping schedule to the point within the unicast sequence at which the device transmits its packet, representing how far the device is into its current unicast hopping sequence at the moment of transmission. An example offset 1008 (e.g., the Broadcast Fractional Offset) spans from the start of CH1 in the broadcast timeline 1004 to the corresponding point of 1006, representing how far the device is from the start of its most recent broadcast slot at the same moment.

Together, the Unicast Fractional Sequence Interval 1006 and the Broadcast Fractional Offset 1008 provide the reference mapping between a device's unicast hopping position and the network's broadcast schedule at a given point in time. By storing this mapping in non-volatile memory and subsequently receiving broadcast timing information from a PAN Configuration frame following a power resumption, a device can recompute its expected unicast hopping sequence position (and that of its neighboring devices) without requiring explicit unicast timing frames. Utilizing the stored information may enable accelerated re-join as described herein.

In some examples (e.g., a Wi-SUN network) devices utilize their own independent unicast hopping sequences. The unicast fractional sequence interval (UFSI) 1006, represents how far the device is in its unicast sequence duration since the start of its own unicast sequence. Unicast sequence duration for DH1CF channel function (a commonly used sequence) is equal to 2¹⁶*unicast dwell time. Similarly, the broadcast interval offset 1008 represents how far the device is from the start of its latest broadcast slot. In some examples, a broadcast slot number is represented by a 2-byte variable that corresponds to a broadcast overall sequence duration that equals 2¹⁶*broadcast interval. The Broadcast Interval may be greater than the unicast dwell time. In such examples, there will be at least one overall unicast sequence which will be a subset of broadcast sequence.

FIG. 11 illustrates a timing diagram depicting a relationship between two points in time first time (t1) 1102 and second time (t2) 1104, which may be utilized to compute a device's expected unicast hopping sequence position at the second time 1104 (e.g., when the sequence interval (UFSI) is not known at the second time 1104). Such an approach enables a device to recalibrate its unicast channel hopping sequence following a power outage or other interruption without requiring an explicit unicast timing frame from a neighboring device. In some examples, the re-join procedures may be performed more quickly than a re-join procedure that requires neighbor communication.

For example, at the first time 1102 (e.g., prior to a power outage), the device may record the following timing state: a Unicast Fractional Sequence Interval value of ufsi1, a broadcast slot number of bs1, and a broadcast interval offset of bfio1. This three-parameter tuple constitutes a reference mapping between the device's unicast hopping sequence position and the network's broadcast schedule. At the second time 1104 (e.g., after an interruption such as a power outage), the device only knows the current broadcast slot number bs2 and the current broadcast interval offset bfio2. For example, the parameters may be obtained from a received PAN Configuration frame following power resumption. The expected unicast fractional sequence interval at the second time 1104, designated ufsi2, may be computed by the device as follows. First, a virtual time delta is computed according to the expression (bfio2*bs2)−(bfio1*bs1), which provides an estimate of the elapsed time in milliseconds between the first time 1102 and the second time 1104 expressed in terms of broadcast timing parameters. Accordingly, the device may compute the expected ufsi2 as ufsi2=ufsi1+(bfio2*bs2)−(bfio1*bs1).

In some examples, the virtual time delta computed by the foregoing expression may not precisely equal the actual real-time elapsed value of the second time 1104 minus the first time 1102 (e.g., in cases where wrap-around occurs such as when the duration of the power outage is significantly longer than a single broadcast sequence duration interval). However, because the computation is directed to establishing a relative timing reference rather than an absolute elapsed time measurement, this virtual elapsed time is sufficient to recalibrate the expected unicast hopping sequence position to a useful degree of accuracy.

Once ufsi2 is determined, the device may resume its unicast hopping sequence from ufsi2, which represents the position within the unicast hopping sequence at which the device would have been operating had the power interruption not occurred. From the perspective of a neighboring device, both the unicast hopping position and the broadcast hopping position of the resuming device may be computed using only the stored UFSI reference information and the current broadcast timing parameters, without requiring an explicit exchange of unicast timing frames between the devices. This enables neighboring devices to predict and track the resuming device's unicast channel sequence, thereby overcoming the challenge of losing unicast hopping synchronization with neighboring devices following a power outage.

In embodiments in which the power outage spans multiple broadcast sequence duration intervals (e.g., an outage lasting several days), the recalibration computation performed from any individual device's perspective may not yield a result that precisely reflects the true elapsed time. However, in embodiments in which all or most devices in the network apply the same recalibration method upon power resumption, neighboring devices will have independently applied the same correction to their own unicast hopping sequences. As a result, neighboring devices will be mutually reachable using the recalibrated sequences. Thus, the network will operate as though power had been restored within a single broadcast sequence duration length, regardless of the actual outage duration.

To account for clock drift accumulated over extended operating periods, devices may periodically store the current UFSI-to-broadcast-schedule mapping in non-volatile memory rather than recording this mapping only at the time of initial network join. For example, the mapping may include the current UFSI value, broadcast slot number, and broadcast interval offset. Upon power resumption, a device may determine whether it was previously operating in accordance with a unicast hopping sequence. If so, the device may perform the recalibration procedure described above upon receipt of broadcast sequence information from any PAN Configuration frame. For example, the device may utilize the most recently stored UFSI-to-broadcast-schedule mapping as the reference tuple for the computation.

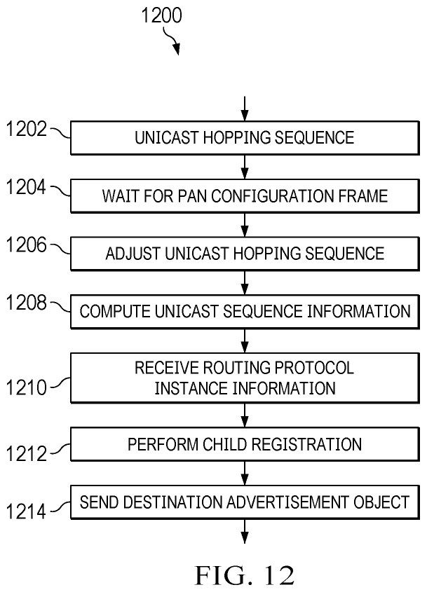

FIG. 12 is a flowchart representative of example machine readable instructions and/or example operations re-joining a device to a Wi-SUN network after power loss that may be executed, instantiated, and/or performed by programmable circuitry to perform an expedited re-join of a device to a Wi-SUN network after a power outage.

The process 1200 of FIG. 12 may be executed by a device employing the unicast hopping recalibration approach to accelerated network re-join following a power outage or other interruption in network participation. In this approach, the re-joining device leverages its stored relationship between its unicast hopping sequence position and the network's broadcast schedule (e.g., as described in connection with FIGS. 10 and 11) to bypass one or more of the network discovery, security exchange, and parent selection steps that would otherwise be required in a full re-join sequence, thereby significantly reducing re-join time.

The process 1200 begins when the device initiates or resumes a unicast hopping sequence (block 1202). For example, the device may skip Join State 1 and Join State 2 illustrated in FIG. 7. For example, upon power resumption, the device begins operating on an initial unicast hopping sequence. In some embodiments, the device may begin with a temporary fixed-channel listening mode, advertising itself via its Unicast Timing and Time Correction Information Element (UTT-IE) as though it is operating on a fixed channel, until broadcast timing information is received. In some examples, the device has previously stored the mapping between its unicast hopping sequence position and the network broadcast schedule in non-volatile memory. The device may additionally store the unicast hopping information of its known parent devices, which enables subsequent recalibration.

Next, the device waits for a PAN Configuration frame (block 1204). The device listens for a PAN Configuration frame broadcast by a neighboring router device or parent. The PAN Configuration frame carries the broadcast timing information (e.g., including the current broadcast slot number and broadcast interval offset) that is utilized to recalibrate the device's unicast hopping sequence position. The device may also transmit PAN Configuration Solicit frames as needed in accordance with the applicable join state procedures to prompt transmission of the PAN Configuration frame.

Next, upon receipt of the PAN Configuration frame, the device adjusts its unicast hopping sequence (block 1206). For example, using the broadcast timing information extracted from the PAN Configuration frame together with the stored UFSI-to-broadcast-schedule reference mapping recorded prior to the power outage, the device computes its expected current unicast fractional sequence interval (UFSI) value as described in connection with FIG. 11. The device then resumes its unicast hopping sequence from this recomputed position, representing the point at which it would have been in its unicast sequence had the power interruption not occurred.

Next, the device computes unicast sequence information for its known parent devices (block 1208). Because neighboring devices that also employ the unicast hopping recalibration method described herein will have made the same type of correction to their own unicast hopping sequences, the re-joining device can predict the current unicast hopping sequence positions of its previously known parent devices using the same broadcast timing information and the stored unicast hopping parameters for those devices. This computation enables the re-joining device to address MAC-level unicast transmissions to its parent without first receiving an explicit unicast timing frame from the parent, which may allow bypassing the neighbor discovery step that would otherwise be required.

Next, the device receives routing protocol instance information (block 1210). The device obtains the RPL instance information needed to transmit a Destination Advertisement Object (DAO) packet. This information may be obtained from any received DIO frame, from previously stored non-volatile memory, or from a vendor-specific Information Element embedded in the PAN Configuration frame, as described in connection with FIG. 8.

Next, the device performs child registration (block 1212). For example, using the computed unicast sequence information for its parent device obtained at block 1208, the re-joining device transmits a child registration message to its parent device via MAC-level unicast transmission, using the device's global IPv6 address. The device assumes that its IPv6 address is unchanged from the prior network session, consistent with the network management assumption that address assignments are preserved across power outage events.

Next, the device sends a Destination Advertisement Object (DAO) packet (block 1214). The device transmits a DAO packet via its parent device to register itself in the RPL DODAG's downward routing table at the LBR (LowPAN Border Router) and waits for a DAO ACK in response. Successful completion of the DAO exchange restores the device's presence in the network routing infrastructure and signifies completion of the accelerated re-join procedure. If no DAO ACK is received after exhausting all stored parent candidates, the device falls back to a regular (e.g., specification-defined) re-join process, ensuring backward compatibility with networks in which not all devices support the unicast hopping recalibration method.

As used herein, integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

FIG. 13 is a block diagram of an example programmable circuitry platform 1300 structured to execute and/or instantiate the example machine-readable instructions and/or the example operations of FIGS. 8, 9, 12 to implement the disclosed re-join processes. The programmable circuitry platform 1300 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1300 of the illustrated example includes programmable circuitry 1312. The programmable circuitry 1312 of the illustrated example is hardware. For example, the programmable circuitry 1312 can be implemented by one or more integrated circuits, logic circuits, FPGAs, microprocessors, CPUs, GPUs, VPUs, DSPs, and/or microcontrollers from any desired family or manufacturer. The programmable circuitry 1312 may be implemented by one or more semiconductor based (e.g., silicon based) devices. In this example, the programmable circuitry 1312 implements the disclosed re-join processes.

The programmable circuitry 1312 of the illustrated example includes a local memory 1313 (e.g., a cache, registers, etc.). The programmable circuitry 1312 of the illustrated example is in communication with main memory 1314, 1316, which includes a volatile memory 1314 and a non-volatile memory 1316, by a bus 1318. The volatile memory 1314 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1316 may be implemented by flash memory and/or any other desired type of memory device. Access to the main memory 1314, 1316 of the illustrated example is controlled by a memory controller 1317. In some examples, the memory controller 1317 may be implemented by one or more integrated circuits, logic circuits, microcontrollers from any desired family or manufacturer, or any other type of circuitry to manage the flow of data going to and from the main memory 1314, 1316.

The programmable circuitry platform 1300 of the illustrated example also includes interface circuitry 1320. The interface circuitry 1320 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1322 are connected to the interface circuitry 1320. The input device(s) 1322 permit(s) a user (e.g., a human user, a machine user, etc.) to enter data and/or commands into the programmable circuitry 1312. The input device(s) 1322 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1324 are also connected to the interface circuitry 1320 of the illustrated example. The output device(s) 1324 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1320 of the illustrated example, thus, typically includes a graphics driver card, a graphics driver chip, and/or graphics processor circuitry such as a GPU.

The interface circuitry 1320 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1326. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1300 of the illustrated example also includes one or more mass storage discs or devices 1328 to store firmware, software, and/or data. Examples of such mass storage discs or devices 1328 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1332, which may be implemented by the machine readable instructions of FIGS. 8, 9, 12, may be stored in the mass storage device 1328, in the volatile memory 1314, in the non-volatile memory 1316, and/or on at least one non-transitory computer readable storage medium such as a CD or DVD which may be removable.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

Notwithstanding the foregoing, in the case of referencing a semiconductor device (e.g., a transistor), a semiconductor die containing a semiconductor device, and/or an integrated circuit (IC) package containing a semiconductor die during fabrication or manufacturing, “above” is not with reference to Earth, but instead is with reference to an underlying substrate on which relevant components are fabricated, assembled, mounted, supported, or otherwise provided. Thus, as used herein and unless otherwise stated or implied from the context, a first component within a semiconductor die (e.g., a transistor or other semiconductor device) is “above” a second component within the semiconductor die when the first component is farther away from a substrate (e.g., a semiconductor wafer) during fabrication/manufacturing than the second component on which the two components are fabricated or otherwise provided. Similarly, unless otherwise stated or implied from the context, a first component within an IC package (e.g., a semiconductor die) is “above” a second component within the IC package during fabrication when the first component is farther away from a printed circuit board (PCB) to which the IC package is to be mounted or attached. It is to be understood that semiconductor devices are often used in orientation different than their orientation during fabrication. Thus, when referring to a semiconductor device (e.g., a transistor), a semiconductor die containing a semiconductor device, and/or an integrated circuit (IC) package containing a semiconductor die during use, the definition of “above” in the preceding paragraph (i.e., the term “above” describes the relationship of two parts relative to Earth) will likely govern based on the usage context.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real-world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein, integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that reduce re-join time in networks (e.g., unsynchronized channel hopping networks such as Wi-SUN networks) through optimized network configuration and channel hopping recalibration. Disclosed systems, apparatus, articles of manufacture, and methods improve the efficiency of using a computing device by allowing a device to re-join the network more quickly after a power interruption through retained state information, accelerated time synchronization, and/or hop recalibration, thereby reducing the overall re-join delay. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to re-join time optimization in multi-hop unsynchronized channel hopping networks are disclosed herein. Further examples and combinations thereof include the following:

Example 1 includes a device comprising a transceiver, a processor configured to establish, via the transceiver, a connection with a wireless network that utilizes channel hopping, determine a current sequence interval based on an earlier sequence interval and difference between a current time and an earlier time associated with the earlier sequence interval, and communicate, via the transceiver, on the wireless network utilizing the current sequence interval.

Example 2 includes the device of example 1, wherein the current sequence interval is a unicast fractional sequence interval (UFSI).

Example 3 includes the apparatus of any one or more of examples 1-2, wherein the processor is to determine the difference between the current time and the earlier time associated with the earlier sequence interval by determining a first product of a broadcast interval offset associated with the current time and a broadcast slot number associated with the current time, determining a second product of a broadcast interval offset associated with the earlier time and a broadcast slot number associated with the earlier time, and determining the difference as the first product minus the second product.

Example 4 includes the device of example 3, wherein the processor is to calculate the current sequence interval as a sum of the earlier sequence interval and the difference.

Example 5 includes the device of example 4, wherein the processor is further configured to adjust a unicast channel hopping schedule of the device based on the current sequence interval, wherein the adjustment sets a current position in the unicast channel hopping schedule to correspond to the current sequence interval computed from a broadcast interval offset and broadcast slot number of an incoming broadcast slot received from the wireless network.

Example 6 includes the apparatus of any one or more of examples 1-5, wherein the processor is configured to establish the connection in response to regaining power after a power loss.

Example 7 includes the device of example 6, further comprising a memory configured to store connection information for the wireless network, wherein the processor is configured to select a network to which a connection was established prior to the power loss.

Example 8 includes the apparatus of any one or more of examples 1-7, further comprising a non-volatile memory, wherein the processor is configured to determine that network security credentials are not stored in the non-volatile memory, and perform a key exchange when the network security credentials are not stored in the non-volatile memory.

Example 9 includes the apparatus of any one or more of examples 1-8, wherein the processor is configured to retrieve parent and neighbor information, the parent and neighbor information including channel hopping information, and utilize the parent and neighbor information to determine a broadcast hopping schedule.

Example 10 includes the apparatus of any one or more of examples 1-9, wherein the processor is configured to, in response to detecting a power loss, cause the device to store a value of a real time clock.

Example 11 includes the apparatus of any one or more of examples 1-10, wherein the processor is configured to, in response to detecting a recovery from a power loss enable a suspended radio operation, and resume communication of the radio operation using a real time clock that continued running while the radio operation was suspended.

Example 12 includes a method comprising connecting to a wireless network that utilizes channel hopping, determining a current sequence interval based on an earlier sequence interval and a difference between a current time and an earlier time associated with the earlier sequence interval, and communicating on the wireless network utilizing the current sequence interval.

Example 13 includes the method of example 12, wherein the current sequence interval is a unicast fractional sequence interval (UFSI).

Example 14 includes the method of any one or more of examples 12-13, wherein the difference between the current time and the earlier time associated with the earlier sequence interval is calculated by determining a first product of a broadcast interval offset associated with the current time and a broadcast slot number associated with the current time, determining a second product of a broadcast interval offset associated with the earlier time and a broadcast slot number associated with the earlier time, and determining the difference as the first product minus the second product.

Example 15 includes the method of example 14, wherein the current sequence interval is calculated as a sum of the earlier sequence interval and the difference.

Example 16 includes the method of example 15, further comprising adjusting a unicast channel hopping schedule based on the current sequence interval, wherein the adjustment sets a current position in the unicast channel hopping schedule to correspond to the current sequence interval computed from a broadcast interval offset and broadcast slot number of an incoming broadcast slot received from the wireless network.

Example 17 includes the method of any one or more of examples 12-16, wherein the connecting is performed in response to regaining power after a power loss.

Example 18 includes the method of example 17, wherein the connecting includes selecting a network to which a connection was established prior to the power loss.

Example 19 includes the method of any one or more of examples 12-18, further comprising determining that network security credentials are not stored in a non-volatile memory, and performing a key exchange when the network security credentials are not stored in the non-volatile memory.

Example 20 includes the method of any one or more of examples 12-19, further comprising retrieving parent and neighbor information, the parent and neighbor information including channel hopping information, and utilizing the parent and neighbor information to determine a broadcast hopping schedule.

Example 21 includes the method of any one or more of examples 12-20, further comprising, in response to detecting a power loss, causing a device to store a value of a real time clock.

Example 22 includes the method of any one or more of examples 12-21, further comprising, in response to detecting a recovery from a power loss enabling a suspended radio operation, and resuming communication of the radio operation using a real time clock that continued running while the radio operation was suspended.

Example 23 includes a non-transitory computer readable medium comprising instructions that, when executed, cause a machine to connect to a wireless network that utilizes channel hopping, determine a current sequence interval based on an earlier sequence interval and difference between a current time and an earlier time associated with the earlier sequence interval, and communicate on the wireless network utilizing the current sequence interval.

Example 24 includes the non-transitory computer readable medium of example 23, wherein the current sequence interval is a unicast fractional sequence interval (UFSI).

Example 25 includes the apparatus of any one or more of examples 23-24, wherein the difference between the current time and the earlier time associated with the earlier sequence interval is calculated by determining a first product of a broadcast interval offset associated with the current time and a broadcast slot number associated with the current time, determining a second product of a broadcast interval offset associated with the earlier time and a broadcast slot number associated with the earlier time, and determining the difference as the first product minus the second product.

Example 26 includes the non-transitory computer readable medium of example 25, wherein the current sequence interval is calculated as a sum of the earlier sequence interval and the difference.

Example 27 includes the non-transitory computer readable medium of example 26, wherein the instructions cause the machine to adjust a unicast channel hopping schedule based on the current sequence interval, wherein the adjustment sets a current position in the unicast channel hopping schedule to correspond to the current sequence interval computed from a broadcast interval offset and broadcast slot number of an incoming broadcast slot received from the wireless network.

Example 28 includes the apparatus of any one or more of examples 23-27, wherein the instructions cause the machine to connect to the wireless network in response to regaining power after a power loss.

Example 29 includes the non-transitory computer readable medium of example 28, wherein the instructions cause the machine to select a network to which a connection was established prior to the power loss.

Example 30 includes the apparatus of any one or more of examples 23-29, wherein the instructions, when executed, cause the machine to determine that network security credentials are not stored in a non-volatile memory, and perform a key exchange when the network security credentials are not stored in the non-volatile memory.

Example 31 includes the apparatus of any one or more of examples 23-30, wherein the instructions, when executed, cause the machine to retrieve parent and neighbor information, the parent and neighbor information including channel hopping information, and utilize the parent and neighbor information to determine a broadcast hopping schedule.

Example 32 includes the apparatus of any one or more of examples 23-31, wherein the instructions, when executed, cause the machine to, in response to detecting a power loss, cause a device to store a value of a real time clock.

Example 33 includes the apparatus of any one or more of examples 23-32, wherein the instructions, when executed, cause the machine to, in response to detecting a recovery from a power loss enable a suspended radio operation, and resume communication of the radio operation using a real time clock that continued running while the radio operation was suspended.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. A device comprising:
a transceiver;
a processor configured to:
establish, via the transceiver, a connection with a wireless network that utilizes channel hopping;
determine a current sequence interval based on an earlier sequence interval and difference between a current time and an earlier time associated with the earlier sequence interval; and
communicate, via the transceiver, on the wireless network utilizing the current sequence interval.

2. The device of claim 1, wherein the current sequence interval is a unicast fractional sequence interval (UFSI).

3. The device of claim 1, wherein the processor is to determine the difference between the current time and the earlier time associated with the earlier sequence interval by:
determining a first product of a broadcast interval offset associated with the current time and a broadcast slot number associated with the current time;
determining a second product of a broadcast interval offset associated with the earlier time and a broadcast slot number associated with the earlier time; and
determining the difference as the first product minus the second product.

4. The device of claim 3, wherein the processor is to calculate the current sequence interval as a sum of the earlier sequence interval and the difference.

5. The device of claim 4, wherein the processor is further configured to adjust a unicast channel hopping schedule of the device based on the current sequence interval, wherein the adjustment sets a current position in the unicast channel hopping schedule to correspond to the current sequence interval computed from a broadcast interval offset and broadcast slot number of an incoming broadcast slot received from the wireless network.

6. The device of claim 1, wherein the processor is configured to establish the connection in response to regaining power after a power loss.

7. The device of claim 6, further comprising a memory configured to store connection information for the wireless network, wherein the processor is configured to select a network to which a connection was established prior to the power loss.

8. The device of claim 1, further comprising a non-volatile memory, wherein the processor is configured to:
determine that network security credentials are not stored in the non-volatile memory; and
perform a key exchange when the network security credentials are not stored in the non-volatile memory.

9. The device of claim 1, wherein the processor is configured to:
retrieve parent and neighbor information, the parent and neighbor information including channel hopping information; and
utilize the parent and neighbor information to determine a broadcast hopping schedule.

10. The device of claim 1, wherein the processor is configured to, in response to detecting a power loss, cause the device to store a value of a real time clock.

11. The device of claim 1, wherein the processor is configured to, in response to detecting a recovery from a power loss:
enable a suspended radio operation; and
resume communication of the radio operation using a real time clock that continued running while the radio operation was suspended.

12. A method comprising:
connecting to a wireless network that utilizes channel hopping;
determining a current sequence interval based on an earlier sequence interval and a difference between a current time and an earlier time associated with the earlier sequence interval; and
communicating on the wireless network utilizing the current sequence interval.

13. The method of claim 12, wherein the current sequence interval is a unicast fractional sequence interval (UFSI).

14. The method of claim 12, wherein the difference between the current time and the earlier time associated with the earlier sequence interval is calculated by:
determining a first product of a broadcast interval offset associated with the current time and a broadcast slot number associated with the current time;
determining a second product of a broadcast interval offset associated with the earlier time and a broadcast slot number associated with the earlier time; and
determining the difference as the first product minus the second product.

15. The method of claim 14, wherein the current sequence interval is calculated as a sum of the earlier sequence interval and the difference.

16. The method of claim 15, further comprising adjusting a unicast channel hopping schedule based on the current sequence interval, wherein the adjustment sets a current position in the unicast channel hopping schedule to correspond to the current sequence interval computed from a broadcast interval offset and broadcast slot number of an incoming broadcast slot received from the wireless network.

17. The method of claim 12, wherein the connecting is performed in response to regaining power after a power loss.

18. The method of claim 17, wherein the connecting includes selecting a network to which a connection was established prior to the power loss.

19-22. (canceled)

23. A non-transitory computer readable medium comprising instructions that, when executed, cause a machine to:
connect to a wireless network that utilizes channel hopping;
determine a current sequence interval based on an earlier sequence interval and difference between a current time and an earlier time associated with the earlier sequence interval; and
communicate on the wireless network utilizing the current sequence interval.

24. The non-transitory computer readable medium of claim 23, wherein the current sequence interval is a unicast fractional sequence interval (UFSI).

25-33. (canceled)
